(19) United States
(12) Patent Application Publication
(10) Pub. No.: US 2026/0163171 A1
(43) Pub. Date: Jun. 11, 2026

(54) FIRE AND EXPLOSION-PROOF CHARGING BOX FOR BATTERY OF ELECTRIC GOLF TROLLEY

(71) Applicant: TED GOLF EQUIPMENT CO., LTD., Changzhou (CN)

(72) Inventors: Jiaxiong Gong, Changzhou (CN); Qian Gong, Changzhou (CN)

(73) Assignee: TED GOLF EQUIPMENT CO., LTD., Changzhou (CN)

(21) Appl. No.: 19/024,093

(22) Filed: Jan. 16, 2025

(30) Foreign Application Priority Data
Dec. 5, 2024 (CN) 202422999150.X

(51) Int. Cl. H01M 50/383; H01M 50/224; H01M 50/249; H01M 50/262; H01M 50/276; H01M 50/358

(52) U.S. Cl. CPC H01M 50/383; H01M 50/224; H01M 50/249; H01M 50/262; H01M 50/276; H01M 50/358; H01M 2220/20

(57) ABSTRACT

The disclosure relates to a fire and explosion-proof charging box for a battery of an electric golf trolley. The fire and explosion-proof charging box includes a box body and a box cover capable of being locked on the box body, where a gas discharge channel is reserved between the box body and the box cover; a sealing plate covering a box opening of the box body is arranged in the box cover; when a gas pressure in the box body rises, the sealing plate can be lifted by the gas pressure to be separated from the box body; and when the gas pressure in the box body drops, the sealing plate is reset to cover the box opening of the box body. According to the disclosure, an explosion of the battery can be limited in the fire and explosion-proof charging box for the battery such that an explosive can be prevented from splashing out, a fire can be prevented, and a safety performance can be improved.

### FIELD

The disclosure belongs to the technical field of battery protection, and particularly relates to a fire and explosion-proof charging box for a battery of an electric golf trolley.

### BACKGROUND OF THE INVENTION

As modern science and technology evolve, a lithium-ion battery, such as a ternary lithium battery and a lithium iron phosphate battery, can be offered as energy sources for an electronic device at any time. Thus, the lithium-ion battery is applied to a wide range of products, including an electric bicycle, an electric vehicle, and an electric golf trolley. A golf trolley is used to hold a golf bag carrying a golf club and the like. An electric golf trolley powered by a lithium battery can be driven electrically instead of manually and is more convenient and easy to use.

Thermal runaway is probably triggered under the conditions of a mechanical damage, a thermal management failure, overcharge, and overdischarge when an existing lithium-ion battery is moved, stored or charged. After the thermal runaway is triggered, a large amount of mixed gas, dust, etc. combustible at a high temperature will be generated, causing a risk of igniting combustibles around the battery. However, a gas channel of an existing fire and explosion-proof charging box for a battery is relatively narrow such that some gas generated after thermal runaway of the battery is triggered cannot be timely discharged. As a result, an explosion and a fire are likely to occur to endanger personal and property safety.

### SUMMARY OF THE INVENTION

An objective of the disclosure is to provide a fire and explosion-proof charging box for a battery of an electric golf trolley, so as to solve the problem that an existing fire and explosion-proof charging box for a battery is likely to cause an explosion hazard.

The fire and explosion-proof charging box for a battery of an electric golf trolley in the disclosure is implemented as follows:
the fire and explosion-proof charging box for a battery of an electric golf trolley includes a box body and a box cover capable of being locked on the box body. A gas discharge channel is reserved between the box body and the box cover.

A sealing plate is arranged on an inner side of the box cover. When the box cover covers the box body, the sealing plate is capable of covering a box opening of the box body. The expression that the sealing plate is capable of covering a box opening of the box body does not mean that the sealing plate and the box opening fit together perfectly, but that the sealing plate can substantially cover the box opening of the box body. When the box cover covers and is locked on the box body, an interior and an exterior of the box body can be isolated from each other to a certain extent. However, gas can still enter and exit the box body through a gap between the box opening and the sealing plate.

When a gas pressure in the box body rises, the sealing plate moves towards a direction of the box cover to be separated from the box body. Thus, the gap between the box opening and the sealing plate can be further enlarged.

When the gas pressure in the box body drops, the sealing plate moves towards a direction of the box body until the box opening of the box is covered. Thus, the gap between the box opening and the sealing plate can be narrowed.

Further, the box cover covers the box opening of the box body. The gas discharge channel is located between an inner wall of the box cover and an outer wall of the box body.

Further, an elastic element is arranged between the sealing plate and the box cover. The elastic element is used to give initial thrust to the sealing plate. Thus, in a normal state, the sealing plate can substantially cover the box opening of the box body. In a situation that an internal gas pressure rises, the sealing plate can overcome the thrust of the elastic element to move in the direction of the box cover to enlarge the gap between the box opening and the sealing plate. Any conventional component capable of providing appropriate elasticity can be selected as the elastic element.

Any number of elastic elements can be arranged at any position between the sealing plate and the box cover, as long as in a normal state, the sealing plate can substantially cover the box opening of the box body, and in a situation that an internal gas pressure rises, the sealing plate can overcome the thrust of the elastic element to move in the direction of the box cover to enlarge the gap between the box opening and the sealing plate.

In general, it may be better to arrange the elastic elements in a symmetrical manner.

In a particular example of the disclosure, a spring is selected as the elastic element.

In a particular example of the disclosure, four springs are arranged and located near four corners of the sealing plate respectively.

In a particular example of the disclosure, a total elastic force of the four springs is 52 N. When the gas pressure in the box body is greater than 52 N, the springs will be compressed, the sealing plate will move towards the direction of the box cover, and the gas will be discharged from the gap between the sealing plate and the box body. Thus, the pressure in the box body can be ensured to not continuously rise such that pressure relief can be achieved.

In a particular example of the disclosure, a through hole is provided on the sealing plate. A connecting column fit in the through hole is arranged on the inner wall of the box cover. The sealing plate moves along the connecting column.

The spring is fit on the connecting column.

A spring seat located on a periphery of the connecting column is arranged on the inner wall of the box cover. The spring is fit in the spring seat.

In a particular example of the disclosure, a connecting bolt fit in a screw hole in the connecting column is arranged on an inner side of the sealing plate.

In a particular example of the disclosure, an elastic sheet is selected as the elastic element.

Four elastic sheets are arranged and located near four corners of the sealing plate respectively.

Further, a moving stroke range of the sealing plate is 1.5 mm to 4 mm.

In a particular example of the disclosure, the box body and the box cover are both made of aluminum alloys.

In a particular example of the disclosure, one side of the box cover is hinged to the box body. A lock pin assembly for locking the box cover and the box body is arranged on the other side opposite the one side.

In a particular example of the disclosure, a hinged seat is arranged on an outer wall of the box body. A hinged plate rotationally connected to the hinged seat is arranged on an outer wall of the box cover.

The hinged plate and the box cover are integrally arranged.

In a particular example of the disclosure, the lock pin assembly includes a lock seat arranged on the outer wall of the box body, a lock plate arranged on the outer wall of the box cover and matching the lock seat, and a lock pin capable of passing through the lock seat and the lock plate to lock the lock seat and the lock plate. By arranging the lock pin assembly, the box cover can firmly close the box body in a locked state.

The lock plate and the box cover are integrally arranged.

In a particular example of the disclosure, the lock plate is arranged in a U-shaped groove of the lock seat in a matching manner. Lock holes opposite each other are provided on two side walls of each of the lock plate and the lock seat. The lock pin is arranged on an inner wall of a U-shaped lock block.

When the U-shaped lock block is moved towards a direction of a side on which the lock pin is located, the lock pin is capable of exiting from the lock holes on the lock plate and is located in a lock hole on a side wall of the lock seat.

When the U-shaped lock block is moved towards a direction facing away from the side on which the lock pin is located, the lock pin passes through the lock holes on the lock plate and a lock hole on at least one side wall of the lock seat.

In a particular example of the disclosure, a charging interface is arranged on the box cover. A power cable of the charging interface passes through the box cover and the sealing plate to extend into the box body.

In a particular example of the disclosure, a handle is arranged on the box cover such that a user can conveniently carry or move the fire and explosion-proof charging box for the battery.

A recess is provided on the box cover.

After the above technical solution is used, the disclosure has beneficial effects as follows:
when the electric golf trolley is required to be charged or stored for a long time, the battery of the electric golf trolley can be taken out and placed in the fire and explosion-proof charging box for a battery of an electric golf trolley provided in the disclosure. When the battery explodes due to thermal runaway, a gas pressure in the box body will instantaneously rise to lift the sealing plate, and gas generated by the explosion can be discharged from the fire and explosion-proof charging box through the gas discharge channel. Thus, the explosion of the battery can be limited in the fire and explosion-proof charging box for the battery such that an explosive can be prevented from splashing out, a fire can be prevented, and a safety performance can be improved.

### BRIEF DESCRIPTION OF DRAWINGS

The disclosure will be further described below in combination with accompanying drawings and examples.

FIG. 1 is a structural diagram of a fire and explosion-proof charging box for a battery of an electric golf trolley according to Example 1 of the disclosure in a first angle of view;

FIG. 2 is a structural diagram of the fire and explosion-proof charging box for a battery of an electric golf trolley according to Example 1 of the disclosure in a second angle of view;

FIG. 3 is a front view of the fire and explosion-proof charging box for a battery of an electric golf trolley according to Example 1 of the disclosure;

FIG. 4 is a sectional diagram in a direction A-A in FIG. 3;

FIG. 5 is an enlarged view of a part B in FIG. 4;

FIG. 6 is a structural diagram of a box cover of the fire and explosion-proof charging box for a battery of an electric golf trolley according to Example 1 of the disclosure;

FIG. 7 is a structural diagram of a box body of the fire and explosion-proof charging box for a battery of an electric golf trolley according to Example 1 of the disclosure; and

FIG. 8 is a structural diagram of a sealing plate of the fire and explosion-proof charging box for a battery of an electric golf trolley according to Example 1 of the disclosure.

In the figures: box body 1, box cover 2, gas discharge channel 3, sealing plate 4, spring 5, connecting column 6, through hole 7, spring seat 8, connecting bolt 9, hinged seat 10, hinged plate 11, lock seat 12, lock plate 13, lock pin 14, lock hole 15, U-shaped lock block 16, charging interface 17, power cable 18, cable hole 19, handle 20, and recess 21.

### DETAILED DESCRIPTION OF THE INVENTION

In order to make objectives, technical solutions and advantages of embodiments of the disclosure clearer, the technical solutions in the embodiments of the disclosure will be clearly and completely described below in combination with accompanying drawings in the embodiments of the disclosure. Apparently, the described embodiments are some embodiments, rather than all embodiments of the disclosure. On the basis of the embodiments of the disclosure, all other embodiments obtained by a person of ordinary skill in the art without making creative efforts all fall within the scope of protection of the disclosure.

Thus, the following detailed descriptions of embodiments of the disclosure in accompanying drawings are not intended to limit the scope of protection of the disclosure, but merely denote selected embodiments of the disclosure. On the basis of embodiments of the disclosure, all other embodiments obtained by a person of ordinary skill in the art without making creative efforts all fall within the scope of protection of the disclosure.

### EXAMPLE 1

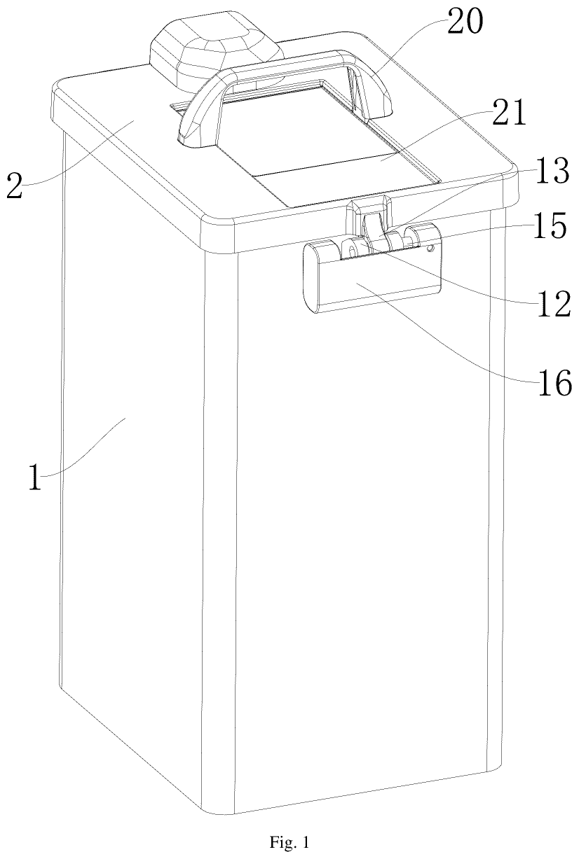

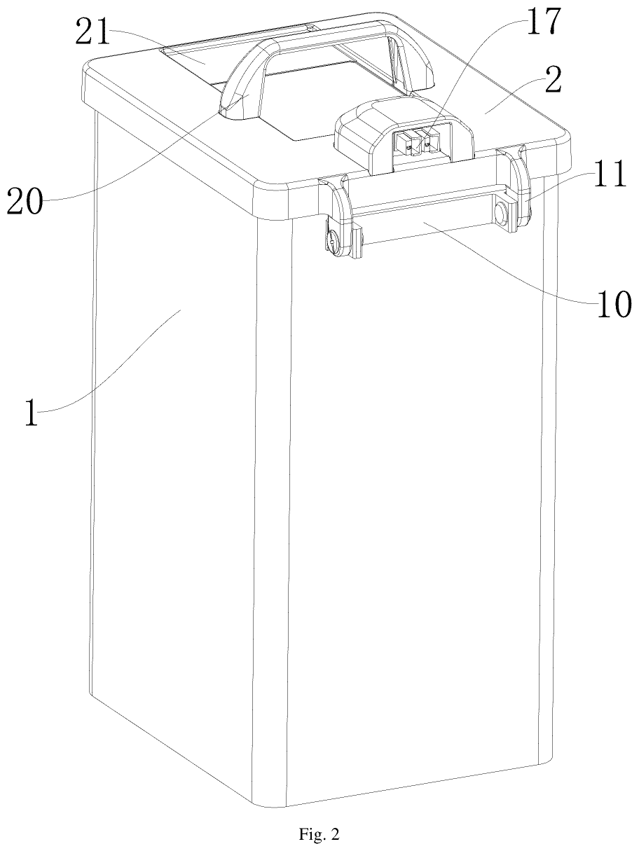

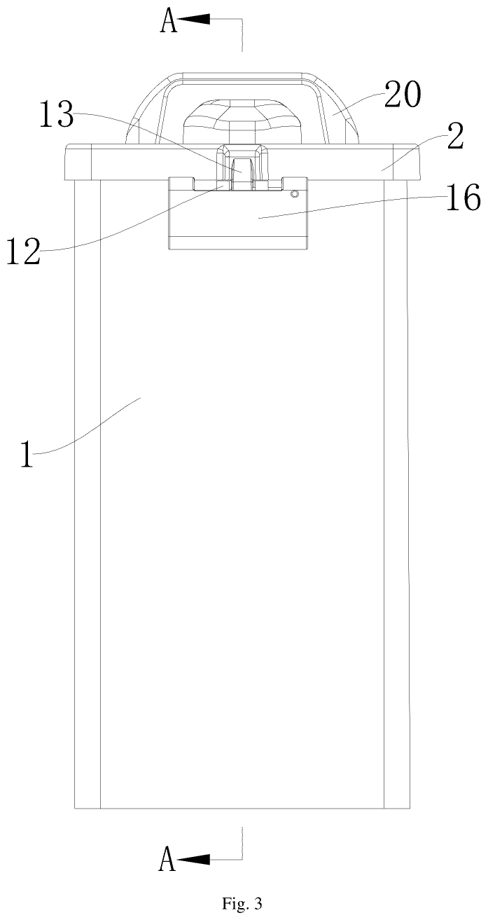

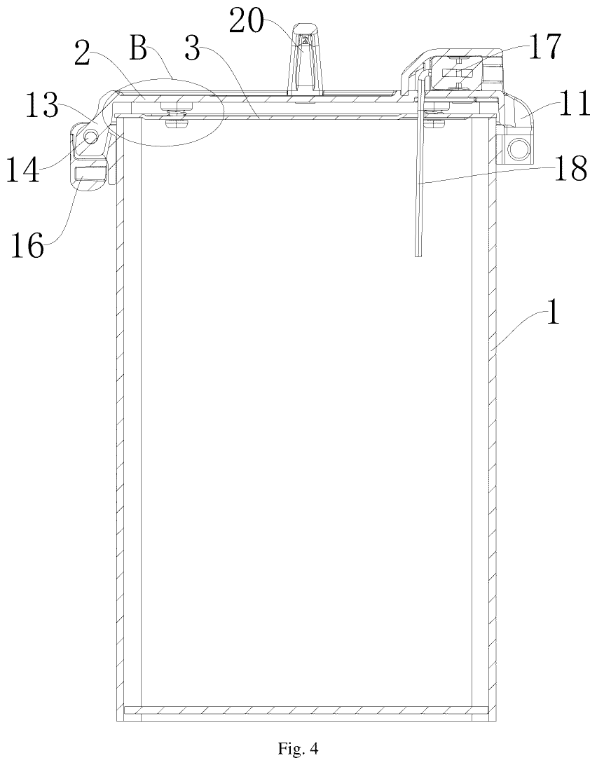

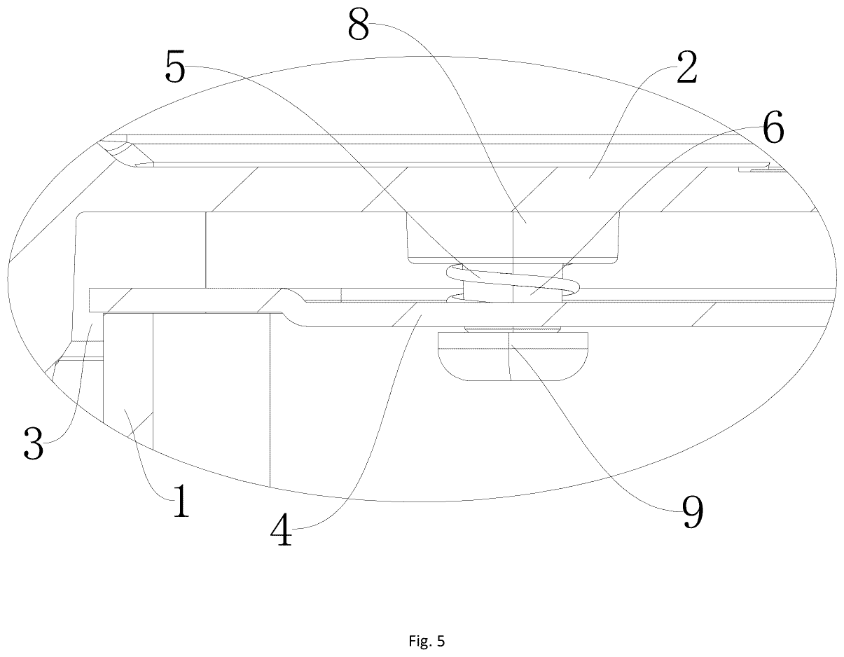

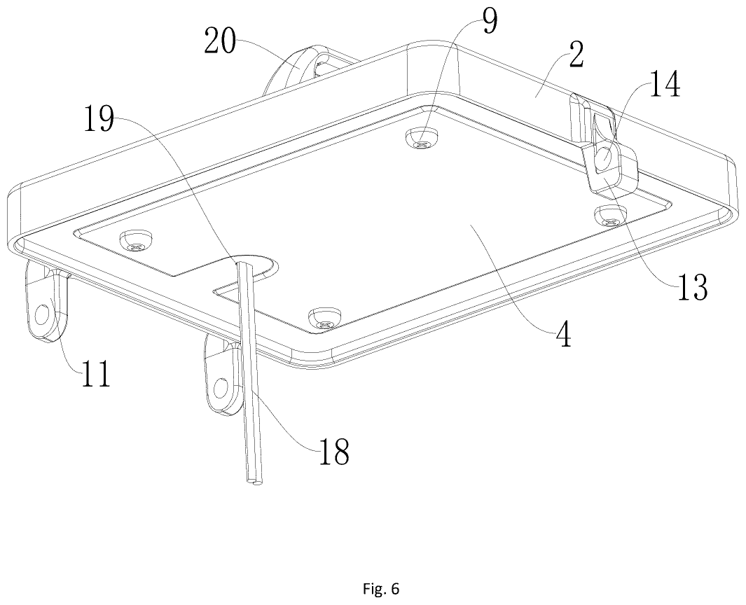

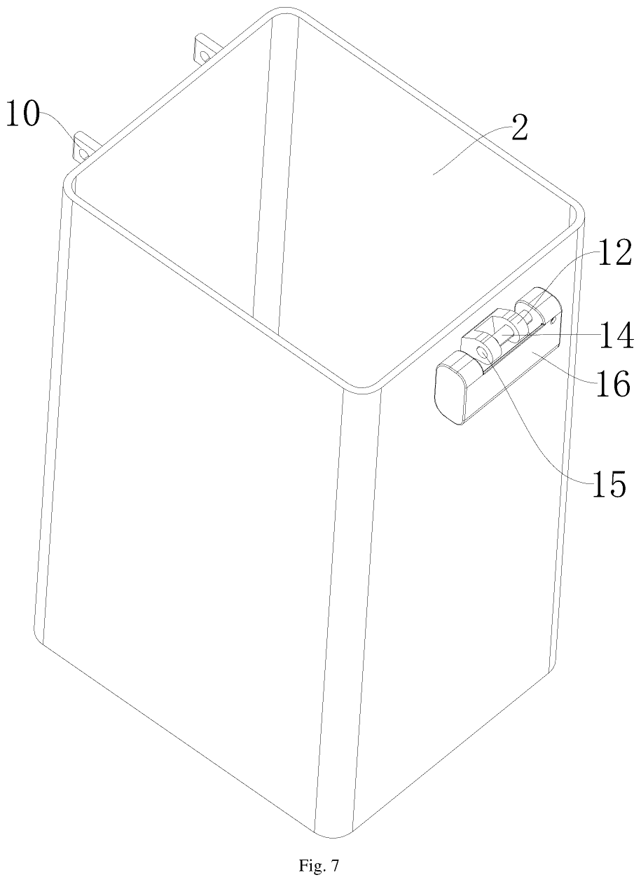

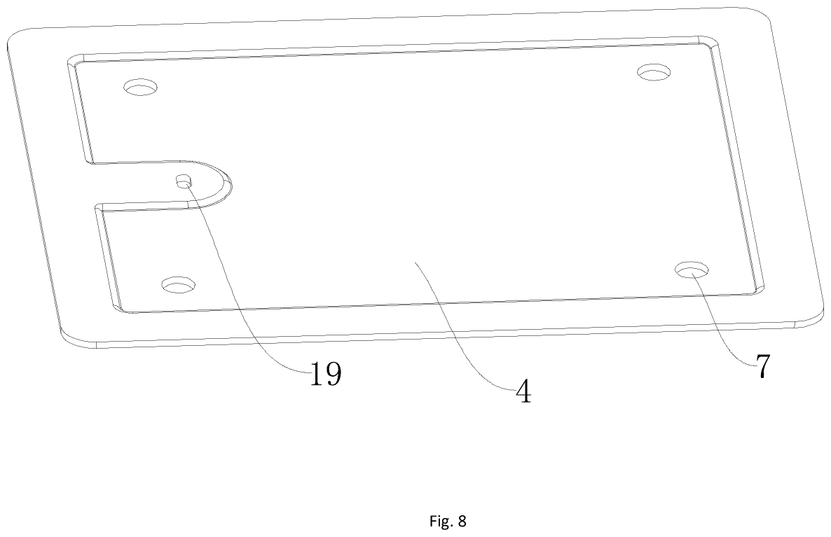

As shown in FIG. 1 to FIG. 8, a fire and explosion-proof charging box for a battery of an electric golf trolley includes a box body 1 and a box cover 2 capable of being locked on the box body 1. A gas discharge channel 3 is reserved between the box body 1 and the box cover 2. A sealing plate 4 is arranged on an inner side of the box cover 2. When the box cover 2 covers the box body 1, the sealing plate 4 is capable of covering a box opening of the box body 1. When a gas pressure in the box body 1 rises, the sealing plate 4 moves towards a direction of the box cover 2 to be separated from the box body 1. When the gas pressure in the box body 1 drops, the sealing plate 4 moves towards a direction of the box body 1 until the box opening of the box body 1 is covered.

When the battery in the box body 1 explodes, the gas pressure will instantaneously rise, and the sealing plate 4 will be lifted by the gas pressure to be separated from the box body 1. During an interval of an explosion or at the end of the explosion, the gas pressure in the box body 1 will gradually drop. At this time, the sealing plate 4 will gradually be reset until the box opening of the box body 1 is covered again.

A battery capacity of the electric golf trolley is 180 Wh to 400 Wh. The disclosure is suitable for preventing an explosion of a battery having such a capacity.

Moreover, a shape of the fire and explosion-proof charging box is not limited to a cuboid, a cube and a cylinder. Other shapes can be adjusted according to requirements.

Preferably, the sealing plate 4 is made of a material including but not limited to a steel plate.

In the example, the fire and explosion-proof charging box is of a vertical cuboid structure. The box opening of the box body 1 is provided on a top of the box body. The box cover 2 covers the top of the box body 1.

When the battery placed in the box body 1 explodes, in order to timely discharge gas generated by the explosion, the box cover 2 covers the box opening of the box body 2. The gas discharge channel 3 is located between an inner wall of the box cover 2 and an outer wall of the box body 1.

In the example, the box cover 2 is of a structure in a square cover shape and includes a top plate and a surrounding plate. A gap is reserved between an inner wall of the surrounding plate and an outer wall of the box body 1 such that the gas discharge channel 3 can be formed. Moreover, the box cover 1 in a square cover shape can play a water-proof role.

In the example, the box body of the box body 1 is connected to the box body 1 through welding.

When no explosion occurs or when the gas pressure in the box body 1 drops, an elastic element is arranged between the sealing plate 4 and the box cover 2.

In the example, the elastic element is a spring 5.

In order to ensure stability of the sealing plate 4 during movement to avoid a deviation, four springs 5 are arranged and located near four corners of the sealing plate 4 respectively.

In order to guide the movement of the sealing plate 4, a through hole 7 is provided on the sealing plate 4, a connecting column 6 fit in the through hole 7 is arranged on the inner wall of the box cover 2, and the sealing plate 4 moves along the connecting column 6.

The spring 5 is fit on the connecting column 6. In this case, the spring 5 is located between the sealing plate 4 and the box cover 2 to buffer the sealing plate 4 during movement and assist the sealing plate 4 to be reset.

In order to ensure stability of the spring 5 during placement, a spring seat 8 located on a periphery of the connecting column 6 is arranged on the inner wall of the box cover 2, and the spring 5 is fit in the spring seat 8.

Specifically, the spring seat 8 is an annular structure around a periphery of the connecting column 6. The spring 5 sleeves the connecting column 6. A top end of the spring is located in the spring seat 8.

When the box cover 2 is opened, the sealing plate 4 is required to be synchronously opened such that the battery can be placed in the box body 1. Thus, in order to connect the box cover 2 to the sealing plate 4, a connecting bolt 9 fit in a screw hole in the connecting column 6 is arranged on an inner side of the sealing plate 4.

In order to timely discharge the gas generated by the explosion in the box body 1, a moving stroke range of the sealing plate 4 is 1.5 mm to 4 mm.

Preferably, the moving stroke range of the sealing plate 4 is 2.5 mm.

A high temperature will be generated when the battery explodes. In order to ensure strength of the fire and explosion-proof charging box, the box body 1 and the box cover 2 are both made of aluminum alloys.

In order to connect and match the box cover 2 to the box body 1, one side of the box cover 2 is hinged to the box body 1. A lock pin 14 assembly for locking the box cover 2 and the box body 1 is arranged on the other side opposite the one side.

In order to hinge the box cover 2 to the box body 1, a hinged seat 10 is arranged on an outer wall of the box body 1. A hinged plate 11 rotationally connected to the hinged seat 10 is arranged on an outer wall of the box cover 2.

The hinged seat 10 is fixed to the outer wall of the box body 1 through welding. Two ends of the hinged seat are hinged to two hinged plates 11 on the outer wall of the box cover 2 correspondingly. The box cover 2 can open or close the box body 1 through the hinging method.

In order to improve the strength of the hinged plate 11, the hinged plate 11 and the box cover 2 are integrally arranged.

In order to lock the box cover 2 and the box body 1, the lock pin 14 assembly includes a lock seat 12 arranged on the outer wall of the box body 1, a lock plate 13 arranged on the outer wall of the box cover 2 and matching the lock seat 12, and a lock pin 14 capable of passing through the lock seat 12 and the lock plate 13 to lock the lock seat and the lock plate.

The lock plate 13, the lock seat 12 and the lock pin 14 match each other. Thus, a thickness of the lock plate 13 can be increased according to requirements. The problem that the lock plate 13 is broken due to an impact of an explosion of the battery can be avoided.

In order to improve strength of the lock plate 13, the lock plate 13 and the box cover 2 are integrally arranged.

Specifically, the lock plate 13 is arranged in a U-shaped groove of the lock seat 12 in a matching manner. Lock holes 15 opposite each other are provided on two side walls of each of the lock plate 13 and the lock seat 12. The lock pin 14 is arranged on an inner wall of a U-shaped lock block 16.

In the example, the lock pin 14 is arranged on a right inner wall of the U-shaped lock block 16.

When the U-shaped lock block 16 is moved towards a direction of a side on which the lock pin 14 is located, the lock pin 14 is capable of exiting from the lock holes 15 on the lock plate 13 and is located in a lock hole 15 on a side wall of the lock seat 12.

In the example, when the U-shaped lock block 16 is moved rightwards to a rightmost position (that is, a left inner wall of the U-shaped lock block 16 abuts against a left side surface of the lock seat 12), the lock pin 14 can exit from the lock hole 15 on a left side wall of the U-shaped lock block 16 and the lock hole 15 of the lock plate 13, and is merely located in the lock hole 15 on the right side wall of the lock seat 12. At this time, the lock plate 13 can be separated from the lock seat 12, and the box cover 2 can be opened.

In this way, the U-shaped lock block 16 can be directly fixed to the lock seat 12. That is, the U-shaped lock block 16 will not be separated from the lock seat 12 such that the U-shaped lock block 16 cannot be lost.

When the U-shaped lock block 16 is moved towards a direction facing away from the side on which the lock pin 14 is located, the lock pin 14 passes through the lock holes 15 on the lock plate 13 and a lock hole 15 on at least one side wall of the lock seat 12.

In the example, when the U-shaped lock block 16 is moved leftwards to a leftmost position (that is, a right inner wall of the U-shaped lock block 16 abuts against a right side surface of the lock seat 12), the lock pin 14 can pass through the lock hole 15 on the right side wall of the lock seat 12, the lock hole 15 on the lock plate 13, and the lock hole 15 on the left side wall of the lock seat 12. Thus, the lock plate 13 and the lock seat 12 can be locked together, and the box cover 2 can be locked on the box body 1.

In order to directly charge the battery when the battery is placed in the box body 1, a charging interface 17 is arranged on the box cover 2. A power cable 18 of the charging interface 17 passes through the box cover 2 and the sealing plate 4 to extend into the box body 1.

Preferably, a cable hole 19 is provided on the sealing plate 4. A power cable 18 of a charging interface 17 extends into the box body 1 through the cable hole 19, so as to be conveniently connected to the battery in the box body 1.

In order to conveniently move the fire and explosion-proof charging box, a handle 20 is arranged on the box cover 2.

In order to conveniently paste usage precautions of the fire and explosion-proof charging box and improve usage safety, a recess 21 is provided on the box cover 2.

A sticker with the usage precautions is directly pasted in the recess 21 such that abrasion to the sticker can be reduced, and the fire and explosion-proof charging box can be ensured to be safely used.

The fire and explosion-proof charging box in the example can be used to place the battery of the electric golf trolley. For instance, the battery can be placed in the fire and explosion-proof charging box during storage, transportation or charging such that an explosion, a fire and other dangerous situations can be avoided.

When the battery is stored, transported or charged, the battery is placed in the fire and explosion-proof charging box, and the box cover 22 and the box body 11 are locked together. In this process, when the battery explodes, the gas pressure in the fire and explosion-proof charging box will instantaneously rise, and the gas pressure will lift the sealing plate 4 upwards (that is, towards a direction of the box cover 2), and compresses the spring 5. At this time, the spring 5 will buffer the sealing plate 4 such that the sealing plate 4 can be separated from the box body 1, and gas can be discharged to the exterior of the fire and explosion-proof charging box through the box opening and the gas discharge channel 3. In this way, an explosion range can be limited in the fire and explosion-proof charging box. Thus, an explosive can be effectively prevented from being randomly splashed, a fire and other situations can be avoided, and safety of the battery during storage, movement or charging can be improved.

Since the battery is formed by connecting a plurality of cells in series, explosions of the cells are mostly intermittent rather than continuous. When an interval of the explosions occurs, the gas pressure in the box body 1 will drop. At this time, the spring 5 will push the sealing plate 4 to cover the box opening of the box body 1 again to seal the box opening of the box body such that the situation that external air enters the box body 1 to cause a fire can be prevented.

### EXAMPLE 2

On the basis of Example 1, the example further provides a fire and explosion-proof charging box for a battery of an electric golf trolley. A structure of the fire and explosion-proof charging box is substantially the same as that in Example 1. A difference lies in that

the elastic element is an elastic sheet.

In the example, the elastic sheet has the same function as the spring in Example 1, and is used to buffer the sealing plate 4 and assist the sealing plate 4 to be reset.

An elastic sheet including but not limited to a V-shaped or Z-shaped elastic sheet can be selected as the elastic sheet. Two ends of the elastic sheet can be fixed to the sealing plate 4 and the box cover 2 respectively through welding or screw connection.

In the example, four elastic sheets are arranged and located near four corners of the sealing plate 4 respectively. By arranging the elastic sheet through such a method, stability of the sealing plate 4 during movement can be ensured to avoid a deviation.

A selection of the elastic element is not limited to the spring 5 or the elastic sheet, but includes a part having elasticity and a buffering effect.

The fire and explosion-proof charging box suitable for the battery of the electric golf trolley having the above electric quantity range, that is, 180 Wh to 400 Wh, regardless of the shape, falls within the range of the fire and explosion-proof charging box for a battery set forth in the disclosure.

Inspired by the ideal example of the disclosure mentioned above, through the above descriptive content, relevant personnel can make various changes and modifications without departing from the scope of the technical idea of the disclosure. The technical scope of the disclosure is not limited to the content in the description, and must be determined according to the scope of the claims.

1. A fire and explosion-proof charging box for a battery of an electric golf trolley, comprising a box body and a box cover capable of being locked on the box body, wherein a gas discharge channel is reserved between the box body and the box cover;
a sealing plate is arranged on an inner side of the box cover, and when the box cover covers the box body, the sealing plate is capable of covering a box opening of the box body;
when a gas pressure in the box body rises, the sealing plate moves towards a direction of the box cover to be separated from the box body; and
when the gas pressure in the box body drops, the sealing plate moves towards a direction of the box body until the box opening of the box is covered.

2. The fire and explosion-proof charging box for a battery of an electric golf trolley according to claim 1, wherein the box cover covers the box opening of the box body, and the gas discharge channel is located between an inner wall of the box cover and an outer wall of the box body.

3. The fire and explosion-proof charging box for a battery of an electric golf trolley according to claim 1, wherein an elastic element is arranged between the sealing plate and the box cover.

4. The fire and explosion-proof charging box for a battery of an electric golf trolley according to claim 3, wherein the elastic element is a spring.

5. The fire and explosion-proof charging box for a battery of an electric golf trolley according to claim 4, wherein four springs are arranged and located near four corners of the sealing plate respectively.

6. The fire and explosion-proof charging box for a battery of an electric golf trolley according to claim 4, wherein a through hole is provided on the sealing plate, a connecting column fit in the through hole is arranged on the inner wall of the box cover, and the sealing plate moves along the connecting column;
the spring is fit on the connecting column; and
a spring seat located on a periphery of the connecting column is arranged on the inner wall of the box cover, and the spring is fit in the spring seat.

7. The fire and explosion-proof charging box for a battery of an electric golf trolley according to claim 6, wherein a connecting bolt fit in a screw hole in the connecting column is arranged on an inner side of the sealing plate.

8. The fire and explosion-proof charging box for a battery of an electric golf trolley according to claim 3, wherein the elastic element is an elastic sheet; and
four elastic sheets are arranged and located near four corners of the sealing plate respectively.

9. The fire and explosion-proof charging box for a battery of an electric golf trolley according to claim 1, wherein a moving stroke range of the sealing plate is 1.5 mm to 4 mm.

10. The fire and explosion-proof charging box for a battery of an electric golf trolley according to claim 1, wherein the box body and the box cover are both made of aluminum alloys.

11. The fire and explosion-proof charging box for a battery of an electric golf trolley according to claim 1, wherein one side of the box cover is hinged to the box body, and a lock pin assembly for locking the box cover and the box body is arranged on the other side opposite the one side.

12. The fire and explosion-proof charging box for a battery of an electric golf trolley according to claim 11, wherein a hinged seat is arranged on an outer wall of the box body, and a hinged plate rotationally connected to the hinged seat is arranged on an outer wall of the box cover; and
the hinged plate and the box cover are integrally arranged.

13. The fire and explosion-proof charging box for a battery of an electric golf trolley according to claim 11, wherein the lock pin assembly comprises a lock seat arranged on the outer wall of the box body, a lock plate arranged on the outer wall of the box cover and matching the lock seat, and a lock pin capable of passing through the lock seat and the lock plate to lock the lock seat and the lock plate; and
the lock plate and the box cover are integrally arranged.

14. The fire and explosion-proof charging box for a battery of an electric golf trolley according to claim 13, wherein the lock plate is arranged in a U-shaped groove of the lock seat in a matching manner, lock holes opposite each other are provided on two side walls of each of the lock plate and the lock seat, and the lock pin is arranged on an inner wall of a U-shaped lock block;
when the U-shaped lock block is moved towards a direction of a side on which the lock pin is located, the lock pin is capable of exiting from the lock holes on the lock plate and is located in a lock hole on a side wall of the lock seat; and
when the U-shaped lock block is moved towards a direction facing away from the side on which the lock pin is located, the lock pin passes through the lock holes on the lock plate and a lock hole on at least one side wall of the lock seat.

15. The fire and explosion-proof charging box for a battery of an electric golf trolley according to claim 1, wherein a charging interface is arranged on the box cover, and a power cable of the charging interface passes through the box cover and the sealing plate to extend into the box body.

16. The fire and explosion-proof charging box for a battery of an electric golf trolley according to claim 1, wherein a handle is arranged on the box cover; and
a recess is provided on the box cover.
